(19) United States
(12) Patent Application Publication
(10) Pub. No.: US 2025/0120450 A1
(43) Pub. Date: Apr. 17, 2025

(54) dual-flavor electronic cigarette with two rotating stress-reducing cylinders

(71) Applicant: Dongguan Deke Electronic Technology Co., Ltd., Dongguan (CN)

(72) Inventor: Jinghua Zhang, Dongguan (CN)

(21) Appl. No.: 18/410,252

(22) Filed: Jan. 11, 2024

(30) Foreign Application Priority Data
Oct. 17, 2023 (CN) 202322792038.4

(51) Int. Cl. A24F 40/60; A24F 40/10; A24F 40/30; A24F 40/42; A24F 40/485; F16C 17/26

(52) U.S. Cl. CPC A24F 40/60; A24F 40/10; A24F 40/30; A24F 40/42; A24F 40/485; F16C 17/26

(57) ABSTRACT

A dual-flavor electrical cigarette with two stress-reducing cylinders includes a housing, two cartridge assemblies, two pairs of bearing assemblies, and two stress-reducing cylinders; each pair of bearing assemblies comprises a first bearing and a second bearing; the two stress-reducing cylinders are arranged in the housing and respectively contain one of the two cartridge assemblies, two pairs of bearing assemblies respectively correspond with one stress-reducing cylinders, the first bearing and the second bearing are respectively arranged at an upper part and a lower part of the stress-reducing cylinder and movably connected therewith; each stress-reducing cylinder is rotated separately by applying force. The dual-flavor electrical cigarette with two stress-reducing cylinders combines dual-flavors with two rotary stress-reducing cylinders so that a user can rotate the stress-reducing cylinders separately, thereby having interestingness.

The present disclosure relates to the technical field of electronic cigarettes, and in particular a dual-flavor electrical cigarette with two stress-reducing cylinders.

### BACKGROUND OF THE INVENTION

The electrical cigarettes are electrical products simulating traditional cigarettes. Currently, the electrical cigarettes in the market have special tastes, such as minty, fruit, etc., improving the taste of smoking. The original electrical cigarettes are mostly set as a single flavor with a single cartridge. But in the existing technology, the electrical cigarettes with doubt cartridges appear, which have two cartridges to improve the selectivity and convenience of users. In addition to relieving their cigarette addiction, users use electrical cigarettes to relieve stress, so there are another e-cigarettes that combine e-cigarettes with a stress-reducing cylinder to improve the relieving stress effect.

For example, CN. Pat. App. Pub. No. 113397214A discloses a one-way gas-guiding electronic cigarette with double cartridges, an air inlet for external air into an atomizing cavity is provided on a base, a regulating ring is rotated on the base, and a first magnetic element is provided on the base, and a second magnetic element is provided on the regulating ring. In use, the user can rotate the regulating ring along the periphery of the base according to a smoke demand for different amounts so that the vent on the regulating ring selectively aligns and communicates with an intake, at this time, the first magnet element is connected with the second magnetic element to locate the position of the regulating ring on the base. When the user continues to rotate the regulating ring relative to the base, the user has to overcome the magnetic suction force between the first magnetic element and the second magnetic element. In this way, when the user feels bored, the user can reduce stress by rotating the regulating ring, obtaining the stress relief effect similar to the manipulation of the magnetic ball toy.

However, the regulating ring in the above patent is used for aligning the vent and the intake on the base which facilitates the user to adjust the regulating ring during smoking, the user only can adjust the regulating ring to relieve stress when he is not smoking state. In addition, currently, there is no technology in the market to apply a stress-reducing structure to an electronic cigarette having a dual-flavor, so that the electronic cigarette having the dual-flavor has a single function, which cannot meet the needs of users to inhale dual-flavor smoke and relieve stress at the same time.

### SUMMARY OF THE INVENTION

The object of the present disclosure is to provide a dual-flavor electrical cigarette with two stress-reducing cylinders, aiming to solve the technical problem that the stress-reducing cylinder of the electrical cigarette in the prior art only can be used in the state of the non-smoking state, and the stress-reducing cylinder is not used on a double-flavor electronic cigarette so that the function of the double-flavor electronic cigarette is single.

To achieve the above object, the dual-flavor electrical cigarette with two stress-reducing cylinders includes a housing, two cartridge assemblies, two pairs of bearing assemblies, and two stress-reducing cylinders; each pair of bearing assemblies comprises a first bearing and a second bearing. The two stress-reducing cylinders are arranged in the housing. The two stress-reducing cylinders respectively contain one of the two cartridge assemblies, two pairs of bearing assemblies respectively correspond with one of the two stress-reducing cylinders, the first bearing and the second bearing are respectively arranged at an upper part and a lower part of the stress-reducing cylinder and movably connected therewith; each of the two stress-reducing cylinders is rotated separately by applying force.

Optionally, each of the two cartridge assemblies comprises an oil storage tank and an atomizing core placed in the oil storage tank.

Optionally, the inner wall of the upper part of each stress-reducing cylinder is provided with a first limiting ring, the top wall of the first limiting ring abuts against the bottom surface of the first bearing; the inner wall of the lower part of each stress-reducing cylinder is provided with a second limiting ring, the bottom wall of the second limiting ring abuts against the top surface of the second bearing.

Optionally, the stress-reducing cylinder is a hollow cylindrical shape.

Optionally, an outer side wall of the housing is provided with two notches, the two notches respectively correspond to the two stress-reducing cylinders.

Optionally, the bottom of the housing is provided with two ventilation holes, and the bottoms of the two cigarette assemblies are respectively provided with a ventilation pipe; the bottoms of the two ventilation pipes are respectively communicated with the two ventilation holes, the tops of the two ventilation pipes are respectively inserted into the bottoms of the two atomizing cores, and two microphone switches are respectively provided between the two ventilation pipes and the two ventilation holes.

Optionally, the bottom of the housing is provided with connecting groove, the two ventilation holes are arranged in the connecting groove, a pick is accommodated in the connecting groove and slidable therein to close one of the ventilation holes.

Optionally, the bottom of the housing is provided with a connecting hole, and the middle of the pick is provided with a connecting rod, arranged in the connecting hole; the cross-sectional size of the connecting rod is smaller than the size of the connecting hole, allowing the connecting rod to move within the connecting hole.

Optionally, the top of the housing is provided with a cigarette holder, and the cigarette holder is provided with a hole, a first groove, and two second grooves in sequence from the top surface to the bottom thereof, the tops of the two second grooves are both connected to the first groove, and the bottoms of the two second grooves respectively correspond to the tops of the two atomizing cores so that smoke can flow through one of the atomizing cores, one of the second grooves, and the first groove in sequence, and finally flow out of the housing from the cigarette holder.

Compared with the prior art, the technical schemes of the dual-flavor electrical cigarette with two stress-reducing cylinders in the embodiment in the disclosure at least have one of the following technical effects:

The electrical cigarette has two flavors by setting two cartridge assemblies, and when in use, the user does not need to carry a plurality of single-flavor electrical cigarettes, thereby saving storage space. The stress-reducing cylinder is movably connected with one pair of bearing assemblies, applying force on the stress-reducing cylinder enables it to rotate, thereby relaxing the user' s moods and relieving stress. In addition, the two stress-reducing cylinders can work without interfering with each other and the cartridge assemblies can work without interfering with each other. The user can rotate one of the stress-reducing cylinder in smoking or non-smoking conditions, with high degrees of freedom to meet their demands in different occasions.

### BRIEF DESCRIPTION OF THE DRAWINGS

In order to more clearly illustrate the technical schemes in the embodiments in the present disclosure, the drawings needed in the embodiments or the prior technical description are briefly introduced below. Obviously, the drawings described below are only some embodiments in the present disclosure, and for those skilled in the art, additional drawings may be obtained according to the drawings below without creative work.

FIG. 1 shows a perspective view of the dual-flavor electrical cigarette with two stress-reducing cylinders according to the embodiment in the present disclosure.

FIG. 2 shows an exploded view of FIG. 1.

FIG. 3 shows a top view of FIG. 1.

FIG. 4 shows a sectional view along A-A line in FIG. 3.

FIG. 5 shows an enlarged view of the part A in FIG. 4.

FIG. 6 shows an enlarged view of the part B in FIG. 4.

### EMBODIMENTS

Embodiments of the present invention are described in detail below, and examples of the embodiments are shown in the attached drawings, in which the same or similar labels represent the same or similar elements or elements with the same or similar function. The embodiments described below by reference to the attached drawings are exemplary and are intended to explain embodiments of the present invention and cannot be understood as limits in the present invention.

In the description of the embodiments of the present invention, it should be understood that the directional indications involved in the embodiments, such as the “length”, “width”, “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specificed azimuth, which cannot be understood as a limitation of the present invention.

Further, the terms “first”, and “second” are used only for description purposes, and cannot be understood as indicating or implying relative importance or implicitly indicating the part of technical features indicated. Thus, features defining “first” and “second” may expressly or implicitly include one or more of the features. In the description of the embodiments of the present invention, the “plurality of” means two or more unless otherwise specifically limits.

In the embodiment of the invention, unless other specified and qualified, the terms “installation”, “connection”, “fixed” and other terms shall be broadly understood, for example, it may be fixed connection, detachable connection, or integration; it may be a mechanical connection or an electrical connection; it may be directly connected or indirectly connected by intermediate media, it may be an internal connection of two components or the interaction of two components. For ordinary technicians in the field, the specific meaning of the above term in the embodiment of the invention can be understood according to the specific circumstances.

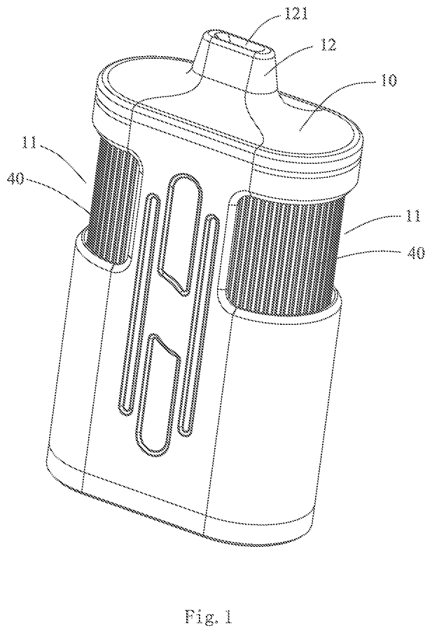

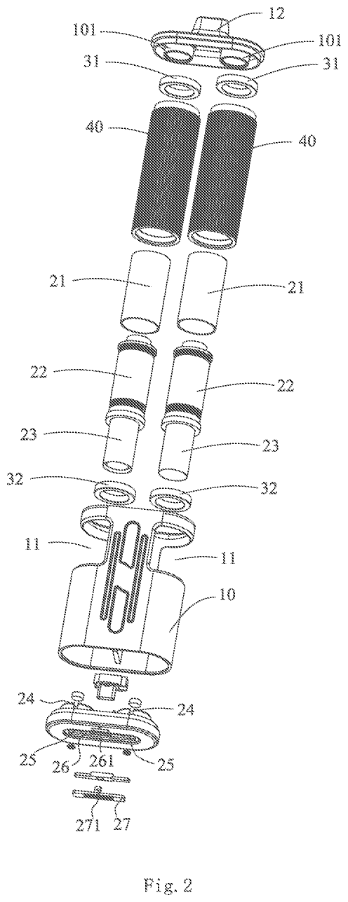

In an embodiment, referring to FIGS. 1-6, it provides an dual-flavor electrical cigarette with two stress-reducing cylinders, which has a housing 10; two cartridge assemblies 20 and two pairs of bearing assemblies 30 are provided in the housing 10. Each of the cartridge assemblies 20 includes an oil storage tank 21 and an atomizing core 22. The oil storage tank 21 is used for storing tobacco tar. The atomizing core 22 is placed in the oil storage tank 21. The tobacco tar in the oil storage tank 21 enters the atomizing core 22, the atomizing core 22 burns the tobacco tar to generate smoke for the user to smoke. The two cartridge assemblies 20 each contain the tobacco tars with different flavors so that the smokes generated in the two atomizing cores 22 have different flavors. The user can enjoy two different smoke flavors by carrying one of the electrical cigarette. The positions of the two pairs of bearing assemblies 30 in the housing 10 correspond to the two cartridge assemblies 20, each of the two pairs of bearing assemblies 30 is respectively movably connected with a stress-reducing cylinder 40, and the stress-reducing cylinder 40 is rotate by applying force.

Compared with the prior art, the technical schemes of the dual-flavor electrical cigarette with two stress-reducing cylinders in the embodiment in the disclosure at least have one of the following technical effects:

The electrical cigarette has two flavors by setting two cartridge assemblies 2, and when in use, the user does not need to carry a plurality of single-flavor electrical cigarettes, thereby saving storage space. The stress-reducing cylinder 40 is movably connected with the bearing assemblies 30, applying force on the stress-reducing cylinder 40 enables it to rotate, thereby relaxing the user moods and relieving stress. In addition, the stress-reducing cylinder 40 and the cartridge assemblies 20 can work simultaneously without interfering with each other. Users can rotate the stress-reducing cylinder 40 in smoking or non-smoking conditions, with high degrees of freedom to meet their demands in different occasions.

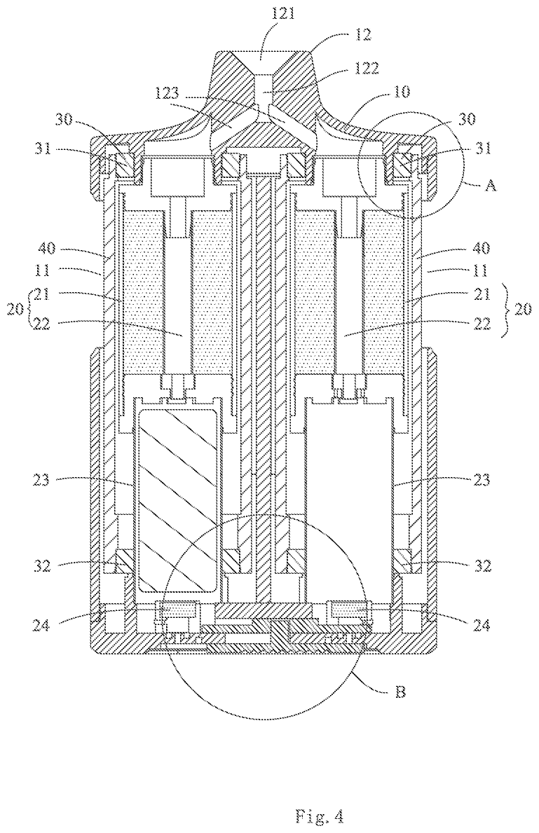

Referring to FIG. 4, each pair of bearing assembly 30 includes a first bearing 31 and a second bearing 32. In the embodiment, the inner top face of the housing 10 is provided with two connecting rings 101, the inner side face of the first bearing 31 abuts against the outer side wall of the connecting ring 101. The gas pipe 23 is provided at the lower part of the housing 10, the inner side wall of the second bearing 32 abuts against the outer wall of the gas pipe 23. In each pair of bearing assembly 30, the second bearing 32 is correspondingly provided below the first bearing 31. The inner bottom wall of the stress-reducing cylinder 40 abuts against the out side wall of the second bearing 32. The stress-reducing cylinder 40 is arranged along the length direction of the housing 10 and can rotate relative to the housing 10, which matches with the hand posture of the user when holding, thereby improving the comfort feel when the user rotates the stress-reducing cylinder 40, and improving the stress-reducing effect.

It should be noted that both the first bearing 31 and the second bearing 32 have an inner ring and an outer ring and can rotate relative to each other. Therefore, the connection position between the stress-reducing cylinder 40 and the first bearing 31, and the connection position between the stress-reducing cylinder 40 and the second bearing 32 are not limited, that is, when the top of the stress-reducing cylinder 40 is connected to the inner side wall of the first bearing 31, the outer side wall of the first bearing 31 is fixed with the housing 10; or when the bottom of the stress-reducing cylinder 40 is connected to the inner side wall of the second bearing 32, the outer side wall of the second bearing 32 is fixed with the housing 10. Meanwhile, the second bearing 32 may also be directly connected to the housing 10 without the gas pipe 23, and as long as the stress-reducing cylinder 40 can rotate relative to the housing 10 through the first bearing 31 and the second bearing 32, it should be considered as belonging to the scope of protection of the present disclosure.

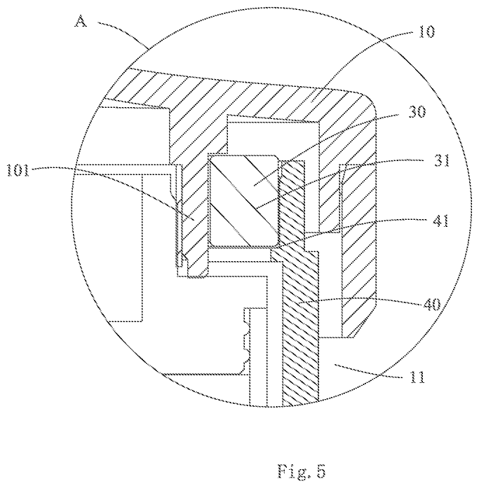

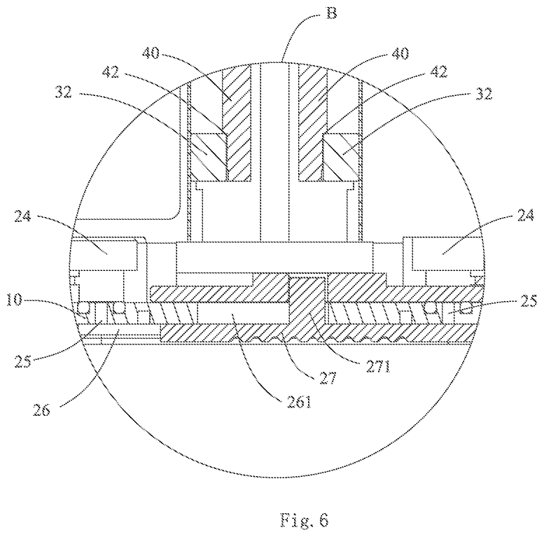

Referring to FIG. 5 and FIG. 6, the inner wall of the upper part of the stress-reducing cylinder 40 is provided with a first limiting ring 41, the top wall of the first limiting ring 41 is plane, abutting against the bottom surface of the first bearing 31. The inner wall of the lower part of the stress-reducing cylinder 40 is provided with a second limiting ring 42, the bottom wall of the second limiting ring 42 is plane, abutting against the top surface of the first bearing 31. The first limiting ring 41 and the second limiting ring 42 are used for limiting the stress-reducing cylinder 40, preventing it from sliding.

Referring to FIG. 4, the stress-reducing cylinder 40 is of a hollow cylindrical shape. In each pair of bearing assembly 30, the first bearing 31 is arranged above the cartridge assemblies 20, and the second bearing 32 is arranged below the cartridge assemblies 20, and the two cartridge assemblies 20 are respectively arranged inside the two stress-reducing cylinders 4, and each of the stress-reducing cylinders 4 is rotated around the outer side of each of the cartridge assemblies 20. This structure can save the inner space of the housing 10, so that the two cartridge assemblies 20 can work independently of each other, and the two stress-reducing cylinders 40 can work independently of each other.

Referring to FIGS. 1 and 4, the outer side wall of the housing 10 is provided with two notches 11, the two notches 11 respectively correspond to the two stress-reducing cylinder 40, and a user holds the stress-reducing cylinder 40 at the notches 11 to rotate it. The shape of each of the notches 11 is not limited herein.

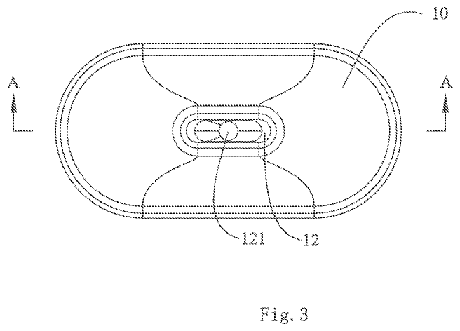

Referring to FIGS. 1 and 3, the bottom of the housing 10 is provided with two ventilation holes 25, and the bottoms of the two cigarette assemblies 20 are respectively provided with a ventilation pipe 23; the bottoms of the two ventilation pipes 23 are respectively communicated with the two ventilation holes 25, the tops of the two ventilation pipes 23 respectively correspond to the bottoms of the two atomizing cores 22, and a microphone switch 24 is provided between the ventilation pipes 23 and the ventilation holes 25; When in use, external air enters the interior of the housing 10 through the ventilation holes 25 to trigger the microphone switch 24, and the microphone switch 24 starts one of the two cigarette assemblies 2, and at the same time, airflow enters the atomizing core 22 through the ventilation pipe 23, so that smoke generated by the atomizing core 22 is taken out of the housing 10 and is smoked by the user. The microphone switch 24 is an air flow trigger switch, and belongs to the prior art which can be obtainable by a person skilled in the art without involving any inventive effort.

Referring to FIG. 6, the bottom of the housing 10 is provided with a connecting groove 26, and both of the two ventilation holes 25 are arranged in the connecting groove 26. A pick 27 is accommodated in connecting groove 26. The pick 27 is slidable in the connecting groove 26 to close one ventilation hole 25, and at this time, the other ventilation hole 25 is open, external air can only enter the housing 10 through the open ventilation hole 25, so that the user can start one of the two cigarette assemblies 20 to smoke the desired flavor.

Further, the inner wall of the connecting groove 26 is provided with a connecting hole 261, the middle of the pick 27 is provided with a connecting rod 271, disposed in the connecting hole 261. The cross-sectional size of the connecting rod 271 is smaller than the size of the connecting hole 261, allowing the connecting rod 271 to move within the connecting hole 261 to drive the pick 27 to slide within the connecting groove 26.

Referring to FIG. 4, the top of the housing 10 is provided with a cigarette holder 12, and the cigarette holder 12 is provided with a hole 121, a first groove 122, and a second groove 122 in sequence from the top surface to the bottom thereof. There are two second grooves 122, the tops of the two second grooves 122 are both connected to the first groove 122, and the bottoms of the two second grooves 122 respectively correspond to the tops of the two atomizing cores 22, so that smoke can flow through one of the atomizing cores 22, one of the second grooves 122, and the first groove 122 in sequence, and finally flow out of the housing 10 from the hole 121 so as to be smoked by the user.

The present disclosure is described in further detail with reference to specific preferred embodiments, and it cannot be determined that the specific embodiments of the present disclosure are only limited to these descriptions. For a person of ordinary skill in the art to which the present disclosure belongs, on the premise of keeping the conception of the present disclosure, the architecture form thereof can be flexible and varied, and a series of products can be derived. It is only to make a few simple deductions or replacements, and all of which should be considered as belonging to the scope of protection of the present disclosure as determined by the claims as filed.

1. A dual-flavor electrical cigarette with two stress-reducing cylinders comprising:
a housing;
two cartridge assemblies;
two pairs of bearing assemblies, each comprises a first bearing and a second bearing; and,
two stress-reducing cylinders, arranged in said housing;
said two stress-reducing cylinders respectively contain one of said two cartridge assemblies, two pairs of bearing assemblies respectively correspond with one of said two stress-reducing cylinders, said first bearing and said second bearing are respectively arranged at an upper part and a lower part of said stress-reducing cylinder and movably connected therewith; each of said two stress-reducing cylinders is rotated separately by applying force.

2. The dual-flavor electrical cigarette with two stress-reducing cylinders according to claim 1, wherein each of said two cartridge assemblies comprises an oil storage tank and an atomizing core placed in said oil storage tank.

3. The dual-flavor electrical cigarette with two stress-reducing cylinders according to claim 2, wherein an inner wall of said upper part of the stress-reducing cylinder is provided with a first limiting ring, a top wall of the first limiting ring abuts against a bottom surface of said first bearing; an inner wall of said lower part of said stress-reducing cylinder is provided with a second limiting ring, a bottom wall of said second limiting ring abuts against a top surface of the second bearing.

4. The dual-flavor electrical cigarette with two stress-reducing cylinders according to claim 1, wherein an outer side wall of said housing is provided with two notches, said two notches respectively correspond to said two stress-reducing cylinders.

5. The dual-flavor electrical cigarette with two stress-reducing cylinders according to claim 2, wherein a bottom of said housing is provided with two ventilation holes, and bottoms of said two cigarette assemblies are respectively provided with a ventilation pipe; a bottom of said ventilation pipe is communicated with said ventilation hole, a top of said ventilation pipe is inserted into to said bottom of said atomizing core, and a microphone switch is provided between the ventilation pipe and the ventilation hole.

6. The dual-flavor electrical cigarette with two stress-reducing cylinders according to claim 5, wherein said bottom of the housing is provided with connecting groove, said two ventilation holes are arranged in said connecting groove, a pick is accommodated in said connecting groove and slidable therein to close one of said ventilation holes.

7. The dual-flavor electrical cigarette with two stress-reducing cylinders according to claim 1, wherein said bottom of the housing is provided with a connecting hole, a middle of said pick is provided with a connecting rod, arranged in said connecting hole to move therein.

8. The dual-flavor electrical cigarette with two stress-reducing cylinders according to claim 1, wherein a top of said housing is provided with a cigarette holder, and said cigarette holder is provided with a hole, a first groove, and two second grooves in sequence from a top surface to a bottom thereof, tops of said two second grooves are both connected to said first groove, and bottoms of said two second grooves are respectively connected to tops of said two atomizing cores so that smoke can flow through said atomizing cores, said second grooves, and said first groove in sequence, and finally flow out of said housing from said cigarette holder.
